(19) United States
(12) Patent Application Publication
(10) Pub. No.: US 2024/0032552 A1
(43) Pub. Date: Feb. 1, 2024

(54) CURING APPARATUS AND METHOD

(71) Applicant: Charles Patrick Parks, Eunice, LA (US)

(72) Inventor: Charles Patrick Parks, Eunice, LA (US)

(21) Appl. No.: 18/363,732

(22) Filed: Aug. 1, 2023

Related U.S. Application Data
(60) Provisional application No. 63/370,004, filed on Aug. 1, 2022.

(51) Int. Cl. A23B 7/144; F24F 11/00

(52) U.S. Cl. CPC A23B 7/144; F24F 11/0008; F24F 2110/20

(57) ABSTRACT

The present invention pertains to an apparatus and method for curing plant matter. The apparatus and method provides for efficiently and effectively curing plant matter, creating a simple and cost-effective solution to address the need for individuals and small entities to cure plant matter. Plant material is placed within a cylindrical housing with a false bottom, a lid is placed on the cylindrical housing and fresh air is cycled into the cylindrical housing, via a pump, to remove the stale air trapped inside and replace it with fresh air. The periodic cycling of fresh air into the chamber provides for a more refined and higher quality product.

### CROSS REFERENCE TO RELATED APPLICATIONS

This application claims benefit to the provisional patent application No. 63/370,004 entitled “Curing Apparatus and Method”, filed on Aug. 1, 2022; the entire contents of which are incorporated by reference in their entirety for all purposes.

### FIELD OF THE INVENTION

The present invention pertains to an apparatus and method for curing plant matter.

### BACKGROUND OF THE INVENTION

Mankind has cultivated and cured plant matter for the entirety of its existence. Archaeological evidence indicates that humans foraged for and consumed plant matter for its medicinal properties as far back as the Paleolithic era, roughly 60,000 years ago. Technological and scientific advances have allowed humans to cure and process plant matter in order to preserve it for later consumption.

Once plant matter is harvested, enzymes and aerobic bacteria begin to break down excess sugars and starches produced by chlorophyll decomposition. Curing the plant matter forces the plant to utilize sugars and starches before the plant matter begins the process of degradation. This essentially stops important and volatile organic compounds from degrading into less useful compounds. There exists an identified need in the plant matter curing market for a device and method to efficiently and effectively cure plant matter. The current devices and methods in the market require large up-front costs that are better suited for commercial enterprises. The present invention of a CURING APPARATUS AND METHOD is a simple and cost-effective invention which addresses the need for individuals and small entities to cure plant matter.

### SUMMARY OF THE INVENTION

The present invention pertains to an apparatus and method for curing plant matter. Embodiments of the present invention as disclosed provide an apparatus and method for the purpose of curing plant matter.

Known curing methods and apparatuses are not entirely satisfactory for the range of applications in which they are employed. Some methods exist, such as U.S. Patent Application Publication. No. US 2015/0096189 (“the '189 Publication”) filed on Oct. 9, 2013, to Hawes et al. The entire contents of the '189 Publication are incorporated herein by reference in their entirety by references for all purposes. The '189 Publication discloses a method for drying cannabis plant material. The method consists of placing cannabis plant material into a chamber, setting the humidity of the chamber to a first humidity and first temperature for a period of time, and then changing the humidity of the chamber to a second humidity level. Further disclosed are subsequent temperature and humidity levels within the chamber. The method of drying cannabis material is lacking in multiple capacities. First, the means of controlling and setting multiple different temperatures and humidity levels requires expensive devices. It is not feasible for small entities and individuals to purchase these expensive devices to cure plant matter efficiently and cost effectively. Second, the '189 Publication fails to cycle fresh air into the curing chamber and remove the stale air trapped inside. The periodic cycling of fresh air into the chamber provides for a more refined and higher quality product. The requirements taught by the '189 Publication to constantly monitor and adjust the humidity and temperature of the chamber is a step which the present invention remedies. Additionally, it is an aspect of the present invention to allow for the evacuation of stale air located within a cylindrical housing allowing for the more refined and higher quality product. The design, quality, and cost-efficiency of the present invention fulfills a present need in the market for small entities and individuals to cure plant matter at a reasonable and upfront cost.

Technological advancements in the curing of plant matter are not satisfactory with regards to the proliferation of individuals who wish to cure certain plant matter on their own. There is an identified need for an easy to use and cost-effective curing apparatus and method which allows small entities and individuals to cure plant matter on their own.

Certain embodiments pertain to an apparatus for curing plant matter which comprises a cylindrical housing with the top of the cylindrical housing having a lid. In certain embodiments the cylindrical housing comprises a bucket. In certain embodiments the cylindrical housing can be accessed from both the top and bottom.

In certain embodiments, a one or more of a one-way valve are affixed to the cylindrical housing for the purpose of allowing old air to be expelled out of the cylindrical housing. Further embodiments comprise a one or more of a one-way valve affixed to a false bottom. One or more of a pop rivet may be affixed to the cylindrical housing in order to hold components of the invention in place. The components of the invention include a circular sheet with a diameter equal to or less than the cylindrical housing which can be used as a false bottom, stackable perforated grates with a diameter equal to or less than the inside diameter of the cylindrical housing, a hygrometer, or an air pump. In certain embodiments, one or more of the stackable perforated grates may be placed upon each other within the cylindrical housing.

In certain embodiments, the air pump is located under the false bottom with one or more of an opening in the false bottom. When activated, the air pump pulls air through a perforated vent affixed to the cylindrical housing in the false bottom and pumps the fresh air into the main compartment of the cylindrical housing. The fresh air is pumped from the false bottom to the main compartment of the cylindrical housing through the false bottom one-way check valves. The fresh air is pumped into the main compartment through one or more of the false bottom one-way check valves and replaces the old air by forcing it out of the cylindrical housing through the one-way valves affixed to the cylindrical housing. In certain embodiments a concave shaped perforated grate may be placed upon the false bottom to prevent the plant matter from covering up the openings in the false bottom. In certain embodiments, the concave shaped perforated grate may be comprised of a strainer or colander.

One or more of a humidity control pack may be freely located within the sealed cylindrical housing, such as a BOVEDA® pack. In certain embodiments, the timer mechanism may automatically turn on one or more of the air pumps.

Certain embodiments of the present invention include a hygrometer or thermometer to measure temperature and moisture content within the cylindrical housing. Measurement of the temperature is an important step as mold and mildew begin to form in environments over 75 degrees Fahrenheit. The formation of mold and mildew is detrimental to the curing process and destroys the quality of the plant matter.

Certain embodiments of the present invention allow for the perforated grates to be stacked above each other within the cylindrical housing to increase the volume of plant matter to be cured.

Certain embodiments of the present invention allow for the cylindrical housing and airtight lid to be comprised of a plastic bucket with a screw on lid and an adapter collar.

The present invention also pertains to a method for curing plant matter which comprises placing the plant matter into a cylindrical housing. At least one or more of a humidity control pack are then placed freely within the cylindrical housing and the cylindrical housing is sealed, creating a stable environment within. One or more of an air pump is then utilized to circulate air through the cylindrical housing, expelling the old air from within.

In certain embodiments of the present invention the plant matter to be cured is cannabis. The method for curing cannabis comprises placing the cannabis into a cylindrical housing. One or more of a humidity control pack are placed freely within the cylindrical housing to help stabilize the moisture content. The cylindrical housing is then sealed to begin the curing process. One or more of an air pump is then utilized to circulate air out of the cylindrical housing through the one-way valves to bring the water content of the cannabis into a predetermined range. A range of 7% to 18% has been found to successful. The cannabis is then removed from the cylindrical housing.

### BRIEF DESCRIPTION OF THE DRAWING

A complete understanding of the present invention may be obtained by reference to the accompanying drawings, when considered in conjunction with the subsequent detailed description, in which:

FIG. 1 is a front view of certain embodiments of a curing apparatus.

FIG. 2 is a front view of certain embodiments of a curing apparatus wherein the lid is removable.

FIG. 3 is a front perspective view of certain embodiments of a curing apparatus.

FIG. 4 is a top view of certain embodiments of a curing apparatus wherein the circular sheet creates a false bottom.

FIG. 5 is a top view of certain embodiments of a curing apparatus wherein the perforated grate is placed above the circular sheet.

FIG. 6 is a side section view of certain embodiments of a curing apparatus wherein the perforated vent is located in the false bottom of the cylindrical housing.

FIG. 7 is a side section view of certain embodiments of a curing apparatus wherein the one-way valve is visible from outside the cylindrical housing.

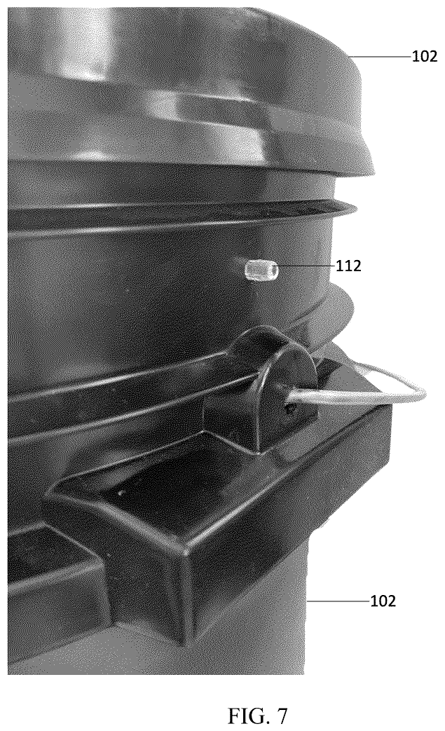

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

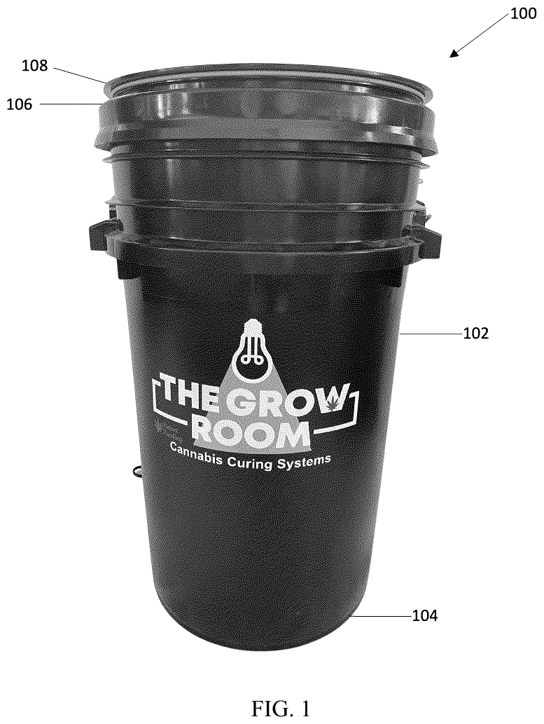

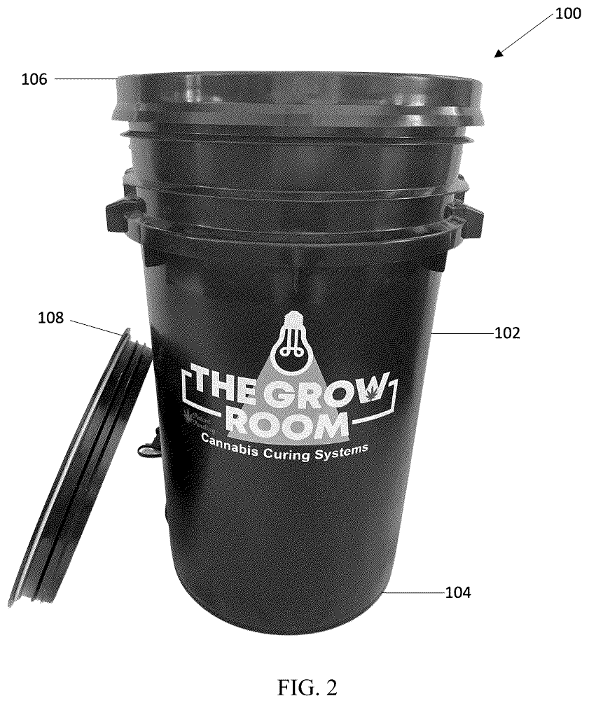

Certain embodiments of an apparatus for curing plant matter 100, seen in FIG. 1 and FIG. 2, comprises a cylindrical housing 102 with a top 104 and a bottom 106, and a lid 108. In certain embodiments, the lid 108 attaches to the top of the cylindrical housing 106 and is an airtight lid and removeable. Such embodiments comprise a false bottom 109 (not shown) within the cylindrical housing 102.

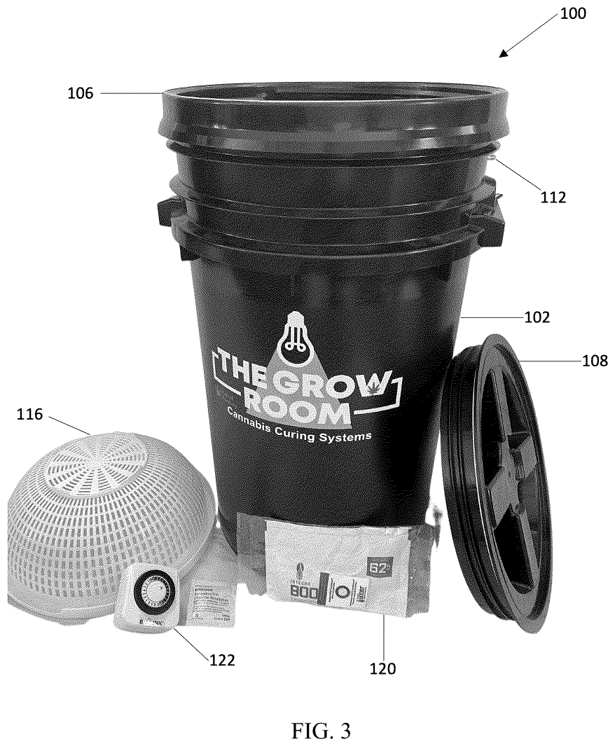

Certain embodiments, seen in FIG. 3, comprise a perforated grate 116 with a diameter equal to or less than the inside diameter of the cylindrical housing 102, one or more of a one way valve 112, one or more of a humidity control pack 120, and a timing mechanism 122.

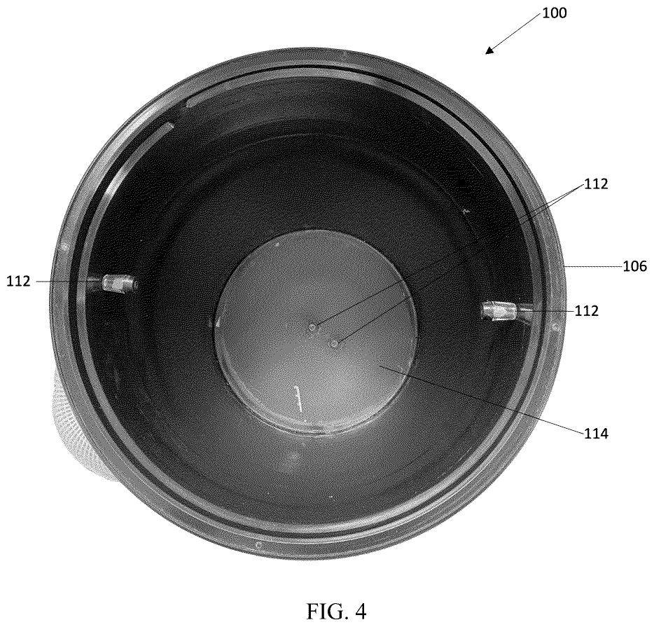

In certain embodiments, as seen in FIG. 4, the false bottom 109 may be created with a circular sheet 114 with a diameter equal to or smaller than the inside diameter of the cylindrical housing, wherein the false bottom is created between the circular sheet 114 and the bottom of the cylindrical housing 104. In certain embodiments, an air pump 110 (not shown) is located within the false bottom 109. In certain embodiments, the air pump 110 is fluidly connected to a one-way valve 112, wherein the one-way valve 112 is attached to the circular sheet 114 for the purpose of allowing new air to be forced into the cylindrical housing 102. Also seen in FIG. 4, one or more of a one-way valve 112 are affixed to the cylindrical housing 102 for the purpose of allowing old air to be expelled out of the cylindrical housing 102. One or more of a pop rivet may be affixed to the cylindrical housing 102 in order to hold components of the invention in place, wherein components may be anything that may need to be affixed or attached to aspects of the apparatus for curing plant matter 100. The components of the invention may include but are not limited to circular sheets 114, perforated grates 116, a hygrometer 118 (not shown), one-way valves 112 or an air pump 110 (not shown).

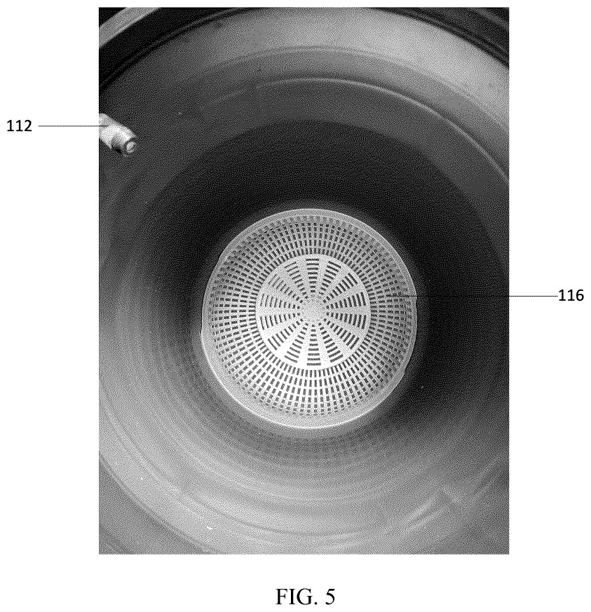

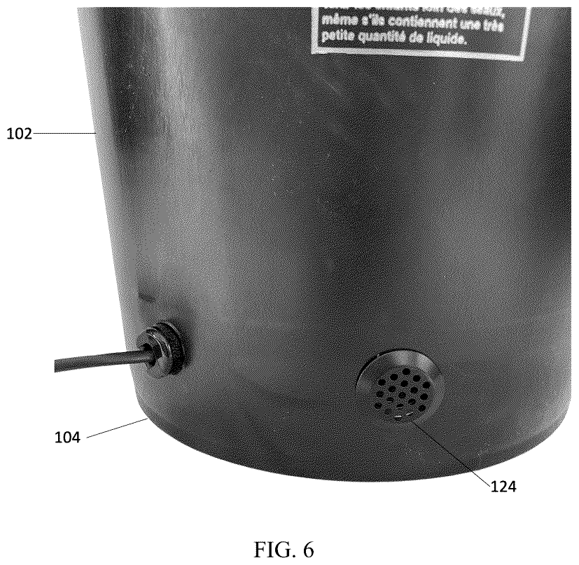

In certain embodiments, as seen in FIG. 5, one or more of the stackable perforated grates 116 may be placed upon each other within the cylindrical housing 102. One or more of a humidity control pack 120 may be freely located within the sealed cylindrical housing 102. A timer mechanism 122 may be used to activate the one or more of the air pumps 110 in order to pull fresh air through a perforated vent 124, as seen in FIG. 6, in the false bottom 109 and pump it into the main chamber of the cylindrical housing, via one-way valves 112, forcing the old air out of the cylindrical housing through the one-way valves 112. In certain embodiments, the timer mechanism 122 may automatically turn on one or more of the air pumps 110.

Certain embodiments of the present invention include a hygrometer 118 (not shown) to measure moisture content within the cylindrical housing 102.

Certain embodiments of the present invention allow for the perforated grates 116 to be stacked above each other within the cylindrical housing 102 to increase the volume of plant matter to be cured. In certain embodiments, the perforated grates 116 may be composed of strainers or colanders.

Certain embodiments of the present invention allow for the cylindrical housing 102 and lid 108 to be comprised of a plastic bucket with a screw on lid and an adapter collar. Certain embodiments may allow for the bottom of the cylindrical housing 104 to be opened and accessed.

Certain embodiments pertain to a method for curing plant matter, which comprises placing the plant matter into a cylindrical housing 102 above the false bottom 109. At least one or more of a humidity control pack 120 are then placed freely within the cylindrical housing 102 and the cylindrical housing 102 is sealed, creating a stable environment within. One or more of an air pump 110 is then utilized to circulate air through the cylindrical housing 102, bringing fresh air through the perforated vent 124 and expelling the old air through the one-way valves 112.

Certain embodiments of the present invention allow for the stacking of a series of perforated grates 116 to allow for multiple layers of plant matter to be stacked upon each other or to keep plant material from directly contacting the false bottom 109 or the one-way valves 112.

Certain embodiments of the present invention allow for the internal humidity to be measured by a hygrometer 118. Other measurable variables may also be calculated, such as temperature via a thermometer.

Certain embodiments of the present invention allow for a timing mechanism 122 to turn on at least one or more of an air pump 110 to circulate air through the cylindrical housing 102 for a predetermined period of time at predetermined intervals. The predetermined time for circulation of air may typically be twice a day for a period of 15 minutes.

In certain embodiments of the present invention the plant matter to be cured is cannabis. The method for curing cannabis comprises placing the cannabis into a cylindrical housing 102. One or more of a humidity control pack 120 are placed freely within the cylindrical housing 102 to help stabilize the moisture content. The cylindrical housing 102 is then sealed to begin the curing process. One or more of an air pump 110 is then utilized to circulate air out of the cylindrical housing 102 through the one-way valves 112 to bring the moisture content of the cannabis into a predetermined range. The curing process time for cannabis can range, where preferable results have been found from 30 days to 90 days. The cannabis is then removed from the cylindrical housing 102.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. An apparatus for curing plant matter, comprising:
a cylindrical housing with a top and a bottom, wherein the bottom is closed and the top is open;
a lid which attaches to the top of the cylindrical housing;
a circular sheet with a diameter equal to or smaller than the inside diameter of the cylindrical housing creating a false bottom between the circular sheet and the bottom of the cylindrical housing;
one or more of an air pump located within the false bottom;
one or more of a one-way valve, a first one-way valve attached to the circular sheet and fluidly connected to the air pump;
a perforated vent affixed to the cylindrical housing between the bottom of the cylindrical housing and the circular sheet; and
a second one-way valve affixed to the cylindrical housing between the circular sheet and the top of the cylindrical housing.

2. The apparatus for curing plant matter of claim 1, further comprising one or more of a perforated grate, located within the cylindrical housing between the circular sheet and the top of the cylindrical housing.

3. The apparatus for curing plant matter of claim 2, wherein the perforated grates are stacked within the cylindrical housing.

4. The apparatus for curing plant matter of claim 1, further comprising one or more of a humidity control pack freely located within the sealed cylindrical housing.

5. The apparatus for curing plant matter of claim 1, further comprising a timer mechanism.

6. The apparatus for curing plant matter of claim 1, further comprising a hygrometer.

7. The apparatus for curing plant matter of claim 1, wherein the cylindrical housing may be comprised of a plastic bucket and the lid screws onto the top of the cylindrical housing.
